(19) United States
(12) Patent Application Publication
(10) Pub. No.: US 2007/0060160 A1
(43) Pub. Date: Mar. 15, 2007

(54) Device for avoidance and resolution of channel time reservation conflict in distributed wireless mac systems, and reservation system having the same and method therefor

(75) Inventors: Kyeong Hur, Seoul (KR); Sunil Dilipkumar Jogi, Bangalore (IN); Yong-suk Kim, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/411,927

(22) Filed: Apr. 27, 2006

(30) Foreign Application Priority Data
Jul. 27, 2005 (KR) 10-2005-0068516

(51) Int. Cl. H04Q 7/20

(52) U.S. Cl. 455/450

(57) ABSTRACT

A data slot reservation system in a distributed wireless personal area network including at least one or more devices. The data slot reservation system includes a first device for broadcasting an extended distributed reservation protocol (DRP) availability information element storing data slot reservation information of at least one neighboring device located in a plutality-hop distance; and a second device for checking reservation states of neighboring devices of the first device by using the extended DRP availability information element, and carrying out a data slot reservation negotiation according to a result of the check. Therefore, the data slot reservation system can avoid reservation conflicts all together, or effectively resolve reservation conflicts when they occur.

### CROSS-REFERENCE TO RELATED APPLICATIONS

This application claims priority from Korean Patent Application No. 10-2005-0068516, filed on Jul. 27, 2005, the entire contents of which are incorporated herein by reference.

### BACKGROUND OF THE INVENTION

1. Field of the Invention

Apparatuses and methods consistent with the present invention relate to a channel time reservation system and method for resolving reservation conflicts by using data slot reservation negotiation in a distributed wireless personal area network.

2. Description of the Related Art

A personal area network (PAN) is a concept contrasting to a local area network (LAN) or a wide area network (WAN), and refers to a network working within a personalized area of about 10 meters. That is, devices owned by one person are configured to form one network for convenience purposes of the person. The implementation of a personal network in a wireless manner is referred to as a wireless personal area network (WPAN).

In an effort to implement the PAN in the wireless manner, the IEEE 802.15 working group defines the WPAN as a standard for short-range wireless networks, and has four affiliate task groups. That is, the standard IEEE 802.15.1 is for Bluetooth, IEEE 802.15.3 and IEEE 802.15.3a are for high-speed WPAN, and the so-called Zigbee standard IEEE 802.15.4 is for low-speed WPAN below 250 Kbps. In the wireless personal area network, the medium is shared among all devices for their mutual communications. To do so, a medium access control protocol is needed to control medium access among the devices.

The medium access control for the wireless personal area network can be designed in two access schemes of ‘centralized’ and ‘distributed’. In the centralized access scheme, devices each operate on behalf of the whole network to manage and adjust the medium access for all the devices. Further, in the distributed access scheme, all the devices share the load of managing their medium access.

FIG. 1 is a view for showing a structure of a wireless personal area network designed in a centralized scheme. The network of FIG. 1 includes networks called ‘piconet’, supporting the centralized medium access control scheme based on the IEEE 802.15.3. One device in the piconet serves as a coordinator called a piconet coordinator (PNC/DEV) 10. The PNC/DEV 10 provides functions of allowing a certain external device to connect to the network, allocating a time slot, sending a beacon for synchronizing signal transmissions among the devices, and so on, which is the ad-hoc centralized wireless personal network system.

FIG. 2 is a view for showing a structure of a wireless personal area network reserving a channel time slot according to the distributed reservation protocol (DRP) without a centralized coordinator.

In FIG. 2, black dots each denote a certain device, and circles centered at each dot each denote a beacon transmission range. In the distributed wireless personal area network, the devices each share necessary information to carry out operations of channel time reservation, synchronization, and so on, under their cooperation.

In detail, each device has to find out a free slot out of beacon slots in order to send a beacon. The devices regularly sending their own beacon are considered a part of the network. Further, the devices need a free data slot to communicate with one another. In order to reserve such a free data slot, transmission and reception devices have to recognize that they are free at a certain data slot. A data slot reservation occurs in a completely distributed manner among the devices sharing information and serving a slot reservation with one another. That is, unlike the centralized wireless personal area control, any device does not just operate as a central coordinator for medium access work. In such a wireless personal area network environment (hereinafter, referred to as ‘distributed WPAN’) according to the distribution mode, a timing concept called ‘superframe’ is used.

FIG. 3 is a view for showing a related art superframe structure. The superframe structure shown in FIG. 3 is based on one defined by the Multiband OFDM (Orthogonal Frequency Division Modulation) Alliance draft V0.5, which includes 256 medium access slots (MASs). A length of the superframe is 64 ms, and a length of each medium access slot is 256 μs.

In FIG. 3, a reference numeral a10 denotes a beacon period configured with a medium access slot used for beacon transmissions. Hereinafter, the MAS corresponding to the beacon period is referred to as a beacon slot, and the MAS corresponding to a data period is referred to as a data slot. Each device can reserve and use a predetermined number of data slots. Information on the superframe is broadcast through the beacon slot allocated to each device. The start time of the superframe is decided by the start of the beacon period, which is defined by the beacon period start time (BPST).

Once a device reserves the MAS, other devices can not reserve a corresponding MAS until the device stops using the reserved MAS. If the corresponding device stops the use of the MAS, the reserved data slots become free. Such free data slots are added to a free data slot pool, and can be reserved for the other devices.

Meanwhile, in the related art system, each device reserves the MAS through reservation negotiations with neighboring devices located within its own beacon transmission range so that the double reservation of the MAS can be avoided. However, there is no way to know the reservation status of a device adjacent to the other devices. Therefore, the MAS employed by the device adjacent to the other devices is likely to be reserved again. If, in such circumstances, a neighboring device moves and comes within the beacon transmission range of the device reserving the MAS, the reservation status of the newly entered device can be overlapped with that of the device reserving the MAS, which causes a problem of reservation conflict.

The related art system does not have efficient countermeasures against the reservation conflict, which causes a problem in that, once the reservation conflict occurs, the system releases the reservation status of all the devices and progresses again with the MAS reservation negotiations. Accordingly, the related art system has a problem of wasting time and electric power needed for a re-reservation process.

### SUMMARY OF THE INVENTION

The present invention provides a data slot reservation system and method in a distributed wireless personal area network, capable of efficiently handling reservation conflict in use of an extended DRP availability information element.

According to an aspect of the invention, there is provided a data slot reservation system in a distributed wireless personal area network having at least one or more devices, comprising a first device for broadcasting an extended distributed reservation protocol (DRP) availability information element storing data slot reservation information of at least one neighboring device located in a several-hop distance; and a second device for, if the extended DRP availability information element is received from the first device, checking reservation states of neighboring devices of the first device by using the extended DRP availability information element, and carrying out data slot reservation negotiation according to a result of the check.

The second device may also decide a reservation-available data slot of data slots not reserved by the neighboring devices of the first device.

Further, the first device may generate a DRP information element for the data slot reservation negotiation, and broadcast the DRP information element together with the extended DRP availability information element.

The DRP information element preferably contains a reservation state storing field for storing a bit value notifying of a reservation negotiation progress state for a certain data slot, a priority storing field for storing a bit value notifying of reservation priority, and a topology information storing field for storing a topology bit value notifying of whether the neighboring devices reserve a certain data slot.

Further, if the DRP information element is received from at least one neighboring device, the first device can combine the received DRP information element and thus generate a DRP availability information element notifying of information on available data slots in a current superframe, and broadcast the DRP availability information element together with the extended DRP availability information element.

Moreover, if the DRP availability information element is received which notifies of the information on the available data slots in a beacon transmission range of each neighboring device from at least one neighboring device, the first device can combine the received DRP availability information element to generate the extended DRP availability information element.

Meanwhile, the extended DRP availability information element may contain a bit as much as the number of data slots in the superframe, and each bit can have a bit value of 0 or 1 depending on whether a corresponding data slot is reserved.

The second device can additionally receive a DRP information element and a DRP availability information element broadcast by the first device.

Thus, the second device can check the DRP availability information element received from the first device and decide whether there exists an available data slot in the current superframe, and, if not, terminate data slot reservation negotiation.

However, if there exists the available data slot in the current superframe, the second device can decide a data slot to reserve, check the extended DRP availability information element received from the first device and decide whether the decided data slot is reserved by neighboring devices of the first device, decide a data slot to reserve, store a result of the decision in a topology information storing field, generate a DRP information element, and broadcast the generated DRP information element.

Meanwhile, if a DRP information element for reservation negotiation for the same data slot as a data slot under current reservation negotiation is received from the first device, the second device can check a reservation negotiation progress state and priority of the first device based on the reservation state storing field and priority storing field of the received DRP information element.

As a result of this check, if the first device has the same reservation negotiation progress state and priority as the second device, the second device can check and compare a topology bit value of the topology information storing field of the DRP information element with that thereof, and decide whether to continue reservation negotiation.

According to another aspect of the invention, there is provided a device operating in a distributed wireless personal area network, comprising an interface part for interfacing with at least one neighboring device operating in the distributed wireless personal area network; a DRP information element generating part for generating a DRP information element for data slot reservation negotiation; a DRP availability information element generating part for, if the DRP information element is received from at least one neighboring device through the interface part, combining each received DRP information element and generating a DRP availability information element notifying of available data slot information of a current superframe; an extended DRP availability information element generating part for, if the DRP availability information element is received from at least one neighboring device through the interface part, combining each received DRP availability information element and generating an extended DRP availability information element notifying of data slot reservation information of neighboring devices located within a several-hop distance; and a control part for broadcasting through the interface part the generated DRP information element, DRP availability information element, and extended DRP availability information element.

The interface part can receive the DRP information element, DRP availability information element, and extended DRP availability information element which are broadcast from at least one neighboring devices.

The DRP information element contains a reservation state storing field for storing a bit value notifying of a reservation negotiation progress state of a certain data slot, a priority storing field for storing a bit value notifying of reservation priority, and a topology information storing field for storing a topology bit value notifying of whether reservation is made by a different device located within a several-hop distance with reference to the device itself.

The extended DRP availability information element may preferably contain a bit as much as the number of data slots in a superframe. Each bit can store a bit value of 0 or 1 depending on whether a corresponding data slot is reserved.

Further, the control part may check the extended DRP availability information element received from at least one neighboring device, and control the DRP information element generating part to generate the DRP information element for reserving a data slot not reserved by devices located with a several-hop distance with reference to each neighboring device.

The control part may also check the DRP availability information element received from at least one neighboring device, decide whether there exists an available data slot in a current superframe, and, if not existing, terminate the data slot reservation negotiation.

If there exists an available data slot in the current superframe, the control part can decide a data slot to reserve, check the extended DRP availability information element received from at least one neighboring device, decide whether the decided data slot is reserved by devices located within a several-hop distance with reference to each neighboring device, decide a data slot to reserve, and control the DRP information element generating part to store a result of the decision in the topology information storing field.

If the DRP information element for reservation negotiation for the same data slot as a data slot under current reservation negotiation is received from a certain first device, the control part can check the reservation negotiation state and priority of the first device from the reservation state storing field and priority storing field of the received DRP information element.

As a result of the check, if the data slot progress state and priority of the current reservation negotiation are the same as those of the first device, the control part can check the topology bit value of the received DRP information element and decides whether to continue reservation negotiation.

According to another aspect of the invention, there is provided a data slot reservation method for devices operating in a distributed wireless personal area network: comprising (a) receiving an extended distributed reservation protocol (DRP) availability information element notifying of data slot reservation information used in a several-hop distance about each neighboring device from at least one or more neighboring devices; and (b) checking reservation states of the neighboring devices with reference to the extended DRP availability information element, and reserving a certain data slot according to a result of the check.

S Operation (b) may include deciding a data slot to reserve out of data slots not reserved by the neighboring devices.

Further, the data slot reservation method may further comprise receiving a DRP information element for the data slot reservation negotiation from at least one neighboring device.

The DRP information element may contain a reservation state storing field for storing a bit value notifying of a reservation negotiation progress state for a certain data slot, a priority storing field for storing a bit value notifying of a reservation priority, and a topology information storing field for storing a topology bit value notifying of whether reservation is made by a different device located within the several-hop distance.

Moreover, the data slot reservation method may further comprise combining the DRP information element received from at least one neighboring device and generating a DRP availability information element notifying of information on available data slots in a current superframe; and broadcasting the generated DRP availability information element.

Further, the data slot reservation method may comprise receiving from at least one neighboring device the DRP availability information element notifying of the information on available data slots within a beacon transmission range of each of at least one or more neighboring devices; and combining the received DRP availability information elements and generating the extended DRP availability information element.

The extended DRP availability information element can contain a bit as much as the number of data slots in a superframe. In here, each bit may store a bit value of 0 or 1 depending on whether a corresponding data slot is reserved.

Further, operation (b) may include checking the DRP availability information element received from at least one neighboring device and thereby determining whether an available data slot exists in a current superframe; and terminating data slot reservation negotiation if there does not exist an available data slot as a result of the check.

Operation (b) may further include checking, if there exists the available data slot as a result of the check, the extended DRP availability information element received from at least one neighboring device, deciding whether the availability data slot is reserved by a different device located within the several-hop distance around at least one neighboring device, and deciding a data slot to reserve; and storing the topology information storing field as a result of the decision to generate the DRP information element, and broadcasting the generated DRP information element.

Further, operation (b) may include checking, if the DRP information element for reservation negotiation for the same data slot as a data slot under current reservation negotiation is received from a certain first device, reservation negotiation progress state and priority of the first device from the reservation state storing field and priority storing field of the received DRP information element.

Operation (b) may further include, if negotiation progress state and priority of a data slot under current reservation negotiation are the same as the reservation negotiation progress state and priority of the first device, checking the topology bit value of the DRP information element received from the first device, and deciding whether to continue reservation negotiation.

Moreover, operation (b) can further include releasing all reservation states of the data slot and progressing with a new reservation negotiation, if the topology bit value of the received DRP information element are the same as the topology bit value thereof; terminating the reservation negotiation if the topology bit value of the received DRP information element is larger than the topology bit value thereof; and continuing the reservation negotiation for the data slot if the topology bit value of the received DRP information element is smaller than the topology bit value thereof.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a view for showing a structure of a centralized wireless personal area network;

FIG. 2 is a view for showing a structure of a distributed wireless personal area network;

FIG. 3 is a view for showing a superframe structure used in a related art distributed wireless personal area network;

FIG. 4 is a block diagram for showing a structure of a device according to an exemplary embodiment of the present invention;

FIG. 5 is a view for illustrating a DRP information element structure used in the device of FIG. 4;

FIG. 6 is a view for showing a DRP availability information element structure used in the device of FIG. 4;

FIG. 7 is a view for showing an extended DRP availability information element structure used in the device of FIG. 4;

FIG. 8 is a view for showing a structure of a distributed wireless personal area network to which the device of FIG. 4 is applied according to an exemplary embodiment of the present invention;

FIG. 9 is a view for explaining a process for avoiding reservation conflicts in the distributed wireless personal area network of FIG. 8;

FIG. 10 and FIG. 11 are views for explaining a process for resolving reservation conflicts in the distributed wireless personal area network of FIG. 8;

FIG. 12 is a flow chart for explaining a data slot decision method for avoiding reservation conflict in the distributed wireless personal area network according to an exemplary embodiment of the present invention;

FIG. 13 is a flow chart for explaining a data slot reservation method in the distributed wireless personal area network according to an exemplary embodiment of the present invention; and

FIG. 14 is a flow chart for explaining a reservation conflict resolving method in the distributed wireless personal area network according to an exemplary embodiment of the present invention.

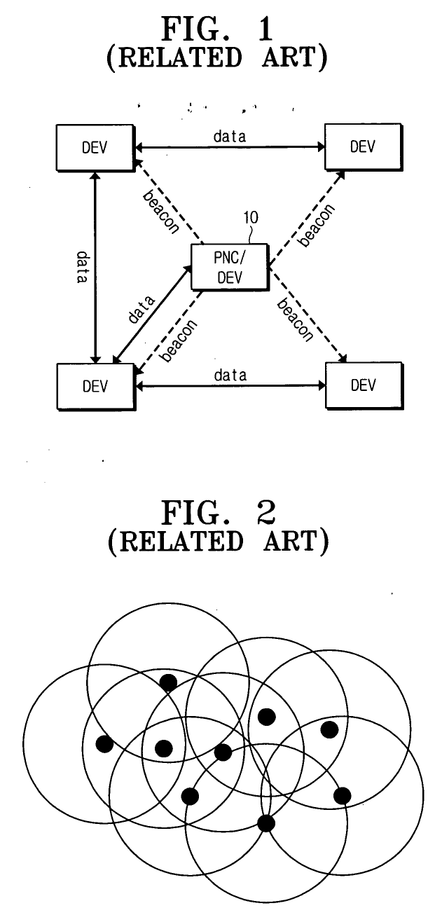

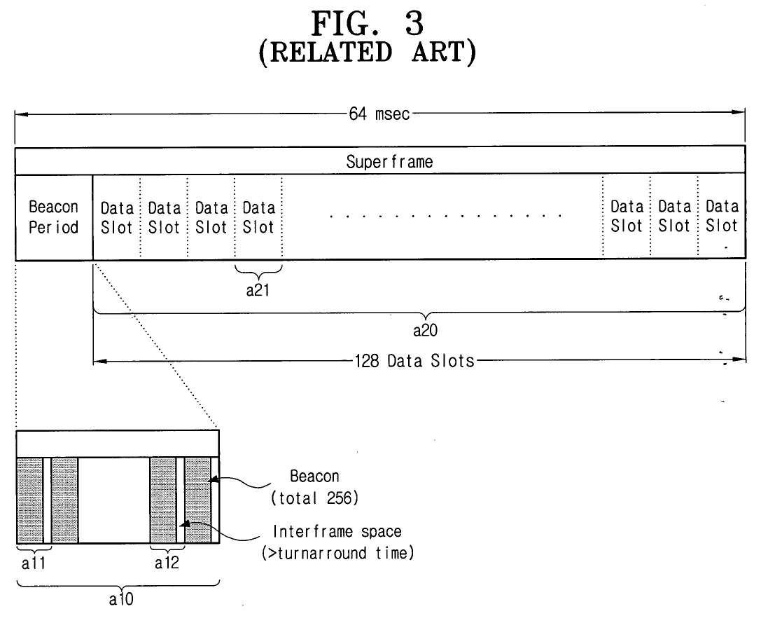

### DETAILED DESCRIPTION OF EXEMPLARY EMBODIMENTS OF THE INVENTION

Hereinafter, the present invention will be described in detail with reference to the accompanying drawings.

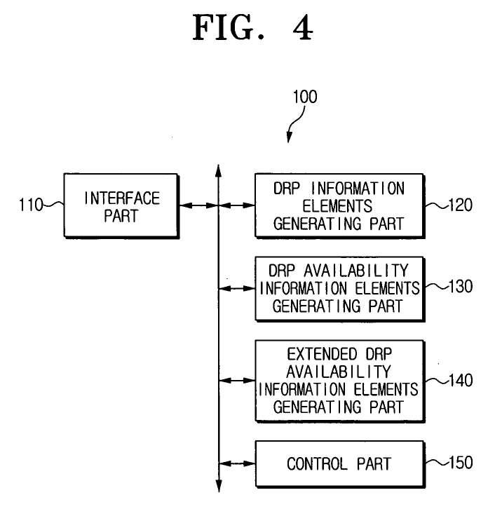

FIG. 4 is a block diagram for showing a structure of a device 100 operating in a distributed wireless personal area network according to an exemplary embodiment of the present invention. The device 100 of FIG. 4 has an interface part 110, a DRP information elements generating part 120, a DRP availability information elements generating part 130, an extended DRP availability information elements generating part 140, and a control part 150.

The interface part 110 interfaces with different devices belonging to the distributed wireless personal area network. Thus, if a different device broadcasts a DRP information element, a DRP availability information element, an extended DRP availability information element, and so on, the interface part 110 receives the broadcast.

The DRP information element is a message used for DRP reservation negotiation, which is used for each device to notify neighboring devices of a reserved data slot thereof. The DRP availability information element is a message used for each device to notify the other devices within its own beacon transmission range of an available data slot; that is, a reservation-available data slot, out of the superframe. The extended DRP availability information element refers to an availability information element reflecting up to information about data slots reserved by neighboring devices with respect to individual devices.

The DRP information elements generating part 120 generates an DRP information element.

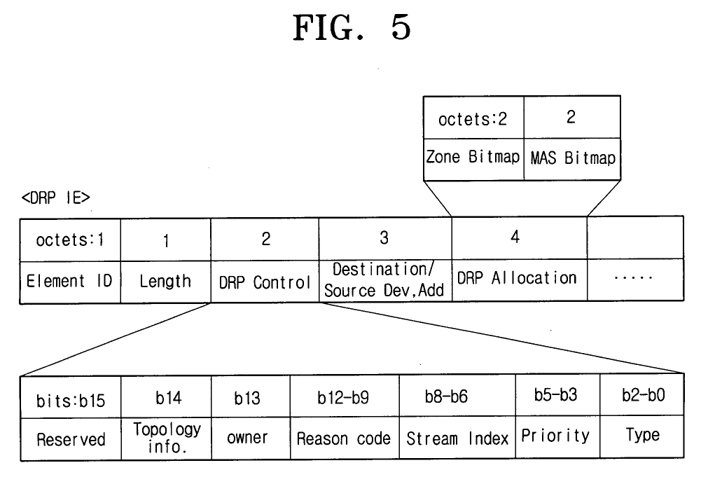

FIG. 5 depicts a structure of a DRP information element. In FIG. 5, the DRP information element contains plural fields storing an element identifier (ID), a message length, DRP control information, destination/source device address, DRP allocation information, and so on.

Of the above, the DRP control information field can be built with 15 bits. The DRP control information field contains a topology information field, a user information field, a reservation state information field, a reason code field, a stream index field, a priority information field, a type information field, and so on.

Of the above, the reservation state information field is a field storing a bit value of “S” for notifying whether a current reservation negotiation is progressing or terminated. Specifically, the reservation state information field stores S=0 during the reservation negotiation, or S=1 during data transmission through a corresponding data slot after reservation negotiation terminates.

The priority information field is an area storing a relative priority in relation with the other devices. Three bits can be used to indicate the priority. If a reservation conflict occurs between two devices having the same reservation state, the reservation of a device with a higher priority is first acknowledged.

The topology information field is an area storing a bit value for notifying a reservation state in an extended area. In detail, the topology information field is an area for storing whether the same data slot is reserved by each neighboring device of the devices adjacent to the present device. If reserved, the topology information field stores a topology bit value of 0, and, if not reserved, stores a topology bit value of 1.

Meanwhile, the DRP allocation information field of the DRP information element contains a zone bitmap and an MAS bitmap. The superframe is divided into 16 areas starting with BPST. Each area contains 16 data slots. Therefore, there exist 256 data slots in the superframe. The DRP allocation information field can be used for designation of a data slot which is to be a reservation negotiation target.

Meanwhile, the DRP availability information elements generating part 130 generates the DRP availability information element. Here, the DRP availability information elements generating part 130 combines the DRP information elements sent from neighboring devices through the interface part 110, and thus, can generate the DRP availability information element.

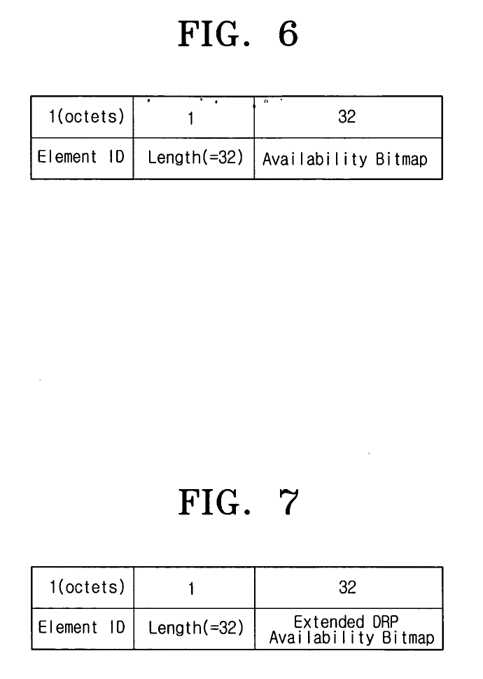

FIG. 6 depicts a structure of a DRP availability information element. In FIG. 6, the DRP availability information element contains a message length and an availability bitmap. The availability bitmap can be built with 256 bits in total. Each bit corresponds to each data slot in the superframe. Accordingly, each bit can notify of whether a data slot is available, that is, reservation-available. In detail, each bit stores a corresponding bit value of 1 if the data slot is available, and stores a corresponding bit value of 0 if the data slot is not available.

Meanwhile, the extended DRP availability information elements generating part 140 generates an extended DRP availability information element for notifying whether a data slot is reservation-available in an extended area.

FIG. 7 depicts a structure of an extended DRP availability information element. In FIG. 7, the extended DRP availability information element contains a message length and an extended DRP availability bitmap. The extended DRP availability bitmap contains a bit as much as the number of data slots in a superframe. Thus, the extended DRP availability bitmap can notify of data slot reservation availability in the extended area as each bit has a bit value of 0 or 1. Compared with the DRP availability information element, there exists a difference in that the DRP availability information element is for notification of reservation states of devices within a one-hop distance from the present device and the extended DRP availability information element is for notification of reservation states of the devices within a several-hop distance, specifically, a two-hop distance from the present device.

The extended DRP availability information elements generating part 140 combines the DRP availability information elements sent from neighboring devices, and thus can generate the extended DRP availability information element. That is, if a neighboring device transmits the DRP availability information element for notifying reservation states of devices within a one-hop distance from itself, the present device can get notified of reservation states of devices within a two-hop distance from itself. Therefore, the extended DRP availability information elements generating part 140 sets to a bit value of 0 a data slot reserved by any device within the two-hop distance and sets to a bit value of 1 a data slot not reserved by any device, thereby generating an extended DRP availability information element.

The control part 150 receives an extended DRP availability information element broadcast from a neighboring device through the interface part 110, and decides a data slot to reserve. That is, the control part 150 decides a data slot, not reserved by a neighboring device, to reserve, taking into consideration data slots reserved by neighboring devices of ambient devices. Since the decision is made with reference to the extended DRP availability information element, the control part 150 can reserve data slots not used for any device within a 3-hop distance with reference to the present device. Thus, the control part 150 controls the DRP information elements generating part 120, and then sets a DRP allocation bitmap of a DRP information element, thereby performing reservation negotiation as to a reservation-decided data slot. As a result, no slot reservation conflict occurs even though devices adjacent to neighboring devices moves in a beacon transmission range of the present device.

Meantime, the control part 150 identifies the DRP information element received from a neighboring device through the interface part 110, and thus identifies whether the DRP information element is an element for reservation of the same data slot as the data slot reserved or under current reservation negotiation by or with itself. That is, the control part 150 checks if there occurs a reservation conflict. The reservation conflict can occur at the time a certain first device newly enters a beacon transmission range of the present device.

If it is determined that the reservation conflict occurs, the control part 150 checks the reservation state information field of the DRP information element received for the first device, and decides whether a bit value is 0 or 1. If the reservation state information bit value of the received DRP information element is 1 (that is, reservation completed) while the present device is currently in reservation negotiation with a corresponding data slot, the control part 150 stops the reservation negotiation. However, if the reservation state information bit value of the received DRP information element is 0 while the present device completely reserves the corresponding data slot, the control part 150 can send data, using the reserved data slot itself. However, if the present device and the first device have the same reservation negotiation state in progress (that is, both devices terminate the reservation or are in reservation negotiation), the control part 150 compares priorities. Thus, if the present device has a higher priority, the control part 150 continues the reservation negotiation if both devices are in reservation negotiation or uses a reserved data slot itself if both devices terminate the reservation.

However, if the first device has a higher priority, the control part 150 terminates the reservation negotiation if both devices are in reservation negotiation or releases the reservation state of the reserved data slot and then resumes the reservation negotiation for a new data slot if both terminate the reservation.

Meanwhile, if the present device and the first device have the same priority, the control part 150 compares a topology bit value. If the present device has a topology bit value of 1 and the first device has a topology bit value of 0 as a comparison result, the control part 150 continues the reservation negotiation if both devices are in reservation negotiation or uses a reserved data slot if both devices terminates reservation. However, if the present device has a topology bit value of 0 and the first device has a topology bit value of 1, the control part 150 stops the reservation negotiation if both devices are in reservation negotiation or releases the reservation state of the reserved data slot and resumes reservation negotiation as to a new data slot if both devices terminate reservation. If the topology bit values are the same, the control part 150 releases all the reservation state as to the corresponding data slot and carries out a new data slot reservation negotiation. The topology bit value of the present device can be set with reference to an extended DRP availability information element received from a neighboring device, which will be described in detail later.

As above, the extended DRP availability information element is used so that a possible reservation conflict is avoided in advance or the conflict is effectively resolved when occurring.

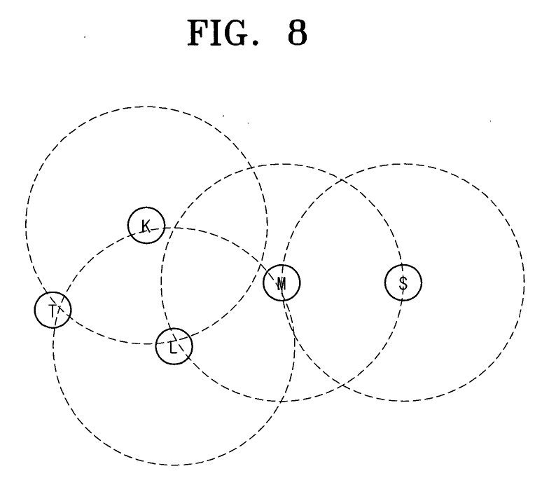

FIG. 8 is a view for showing a structure of a distributed wireless personal area network according to an exemplary embodiment of the present invention. In FIG. 8, the distributed wireless personal area network includes plural devices T, K, L, M, and S. A dotted circle drawn to have the center at each device T, K, L, M, or S refers to a beacon transmission range of each device.

Description will be made based on the device M as below. The device M broadcasts a DRP information element, a DRP availability information element, and an extended DRP availability information element. Thus, the devices L and S located within the beacon transmission range of the device M receive the DRP information element, the DRP availability information element, and the extended DRP availability information element.

The DRP availability information element broadcast by the device M contains the data slot reservation state of the device L located within the one-hop distance from the device M (that is, a beacon transmission range).

Further, the extended DRP availability information element broadcast by the device M contains the data slot reservation states of the device T and K located within a two-hop distance from the device M.

As a result, the device S checks the extended DRP availability information element broadcast by the device M, and thus can be informed of the data slot reservation states of the devices T and K located within a 3-hop distance from itself. Therefore, the device S carries out a reservation negotiation for a data slot not reserved by the devices T and K. Thus, any reservation conflict does not occur as the devices T and K move within the beacon transmission range of the device M.

Meanwhile, the topology bit value is set to 0 at the time the device S has to reserve the data slot reserved by the devices T and K. However, the topology bit value is set to 1 at the time the device S reserves a data slot not reserved by the devices T and K. The set topology bit value can be used as a new priority other than existing priority at the time a reservation conflict occurs.

Meanwhile, if a certain device moves in the beacon transmission range of the device M and thus a reservation conflict occurs, the device M sequentially compares a reservation state, a priority, a topology bit value, and so on, and thus resolves the conflict. Description will be later made in detail on a conflict resolution method.

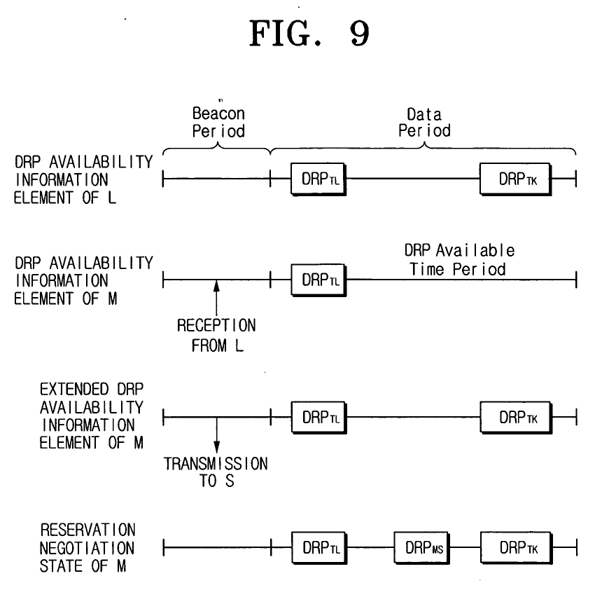

FIG. 9 is a view for explaining a reservation negotiation process in the distributed wireless personal area network of FIG. 8. In view of the DRP availability information element broadcast by the device L in FIG. 9, it can be seen that a certain data slot is reserved in relation with the device T in the transmission range of the device L and a certain data slot is reserved between the devices T and K. Meanwhile, in view of the DRP availability element of the device M, only the data slot reservation state between the devices T and L appears. That is, since the device K is located out of the beacon transmission range of the device M, the data slot reservation state of the device K does not appear in the DRP availability information element of the device M. However, if the DRP availability information element is received from the device L, the device M reflects the data slot reservation state of the device L and thus generates an extended DRP availability information element. In FIG. 9, the extended DRP availability information element of M shows the data slot reservation state between the devices T and L as well as the data slot reservation state between the devices T and K located within a two-hop distance. The device M broadcasts and transmits such an extended DRP availability information element to the device S.

Therefore, the device S decides a data slot to reserve among the data slots except the reserved data slot between the devices T and L. Accordingly, a reservation conflict can be prevented even though any of the devices T and K moves away.

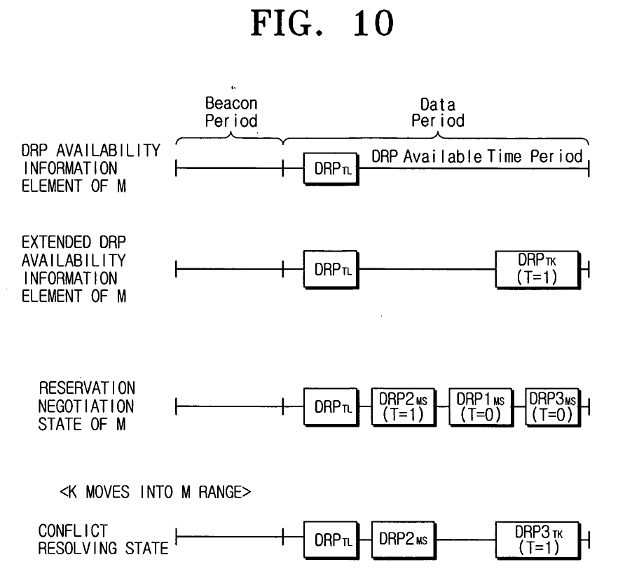

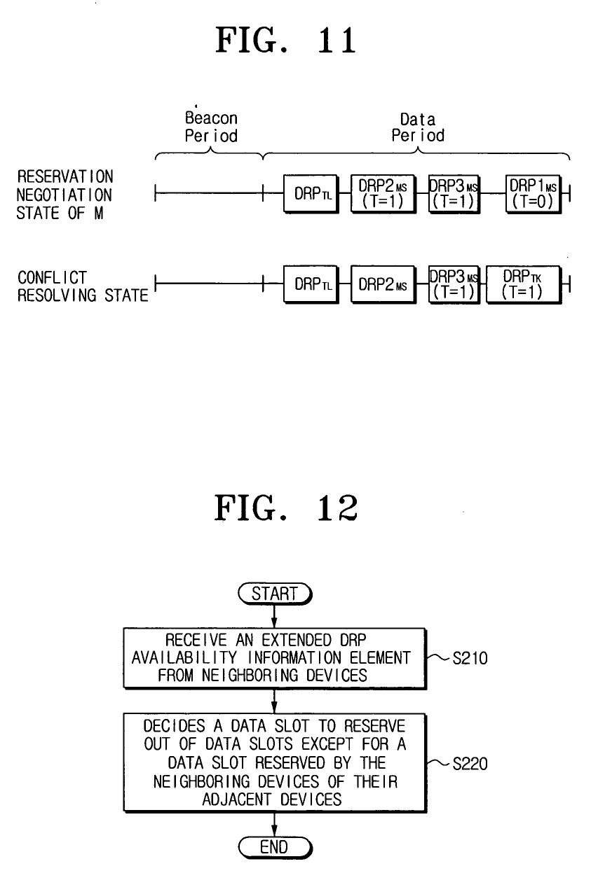

FIGS. 10 and 11 are views for explaining a process of resolving a reservation conflict should it occur. FIGS. 10 and 11 are based on the state that the device M broadcasts the same extended DRP availability information element as that of FIG. 9. In FIG. 10, while three reservation negotiations are carried out between the devices M and S (DRP1, 2, 3), the movement of the device K into the range of the device M causes a reservation conflict between the devices M and K. Specifically, out of the three reservation negotiations, a conflict occurs between the reservation negotiations of the two DRPs (DRP1, DRP3) and the device K. If the reservation state and the priority are the same, the topology bit values are compared for a reservation priority determination. In FIG. 10, the topology bit value of the DRP information element sent from the device K is 1, DRP1 is 0, and DRP3 is 0. Therefore, the reservation negotiation of the device K is acknowledged first of all. Consequently, the conflict is resolved in the manner that the DRP1 and DRP3 negotiations are terminated and the DRPTK negotiation is maintained.

FIG. 11 shows that the device M carries out one reservation negotiation DRP1 overlapped with the device K and two reservation negotiations DRP2 and DRP3 not overlapped with the device K in association with the device S. Likewise in FIG. 10, it is assumed the reservation state and priority of each reservation negotiation are the same as in the device K. In here, the two reservation negotiations DRP2 and DRP3 not overlapped are carried out as they are. However, it is decided depending on a topology bit value whether the overlapped reservation negotiation DRP1 continues. In FIG. 11, since the DRP1 has the topology bit value of 0, the DRP1 comes in priority behind the DRPTK having the topology bit value of 1. As a result, the conflict is finally resolved in the manner that the DRP1 negotiation is terminated and the DRP2, DRP3, and DRPTK are maintained.

FIG. 12 is a flow chart explaining a reservation conflict avoidance method in the distributed wireless personal area network according to an exemplary embodiment of the present invention. In FIG. 12, each device operating in the distributed wireless personal area network receives an extended DRP availability information element from neighboring devices (S210).

Thus, each device recognizes data slot reservation states of devices adjacent to each neighboring device, and decides reservation for a data slot not reserved by the neighboring devices and their adjacent devices (S220). Consequently, all reservation conflicts can be avoided before they occur.

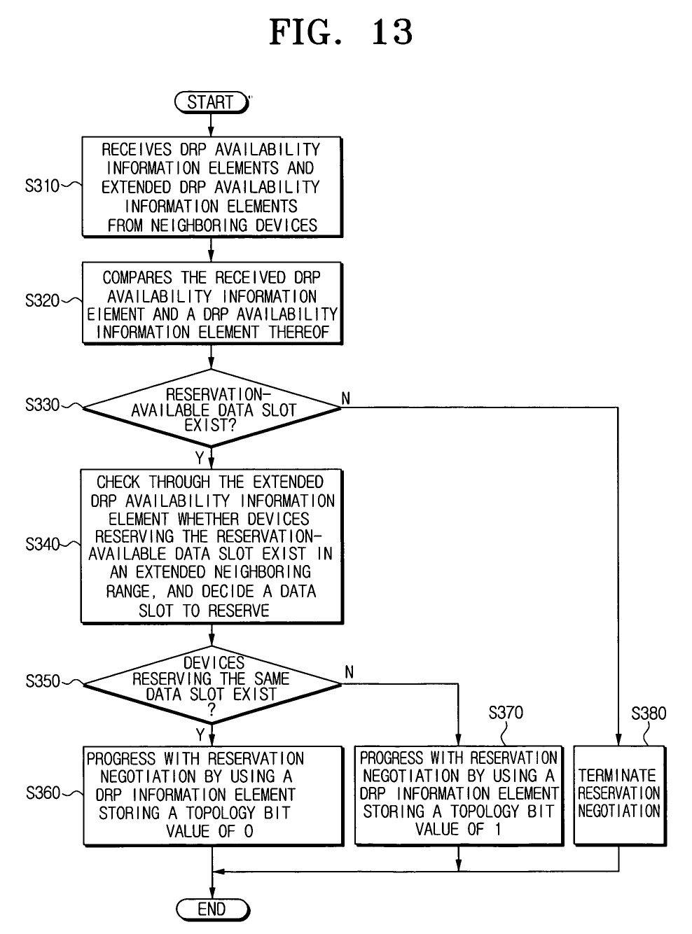

FIG. 13 is a flow chart for explaining a data slot reservation method for a device operating in the distributed wireless personal area network according to an exemplary embodiment of the present invention.

In FIG. 13, the present device receives DRP availability information elements and extended DRP availability information elements from neighboring devices (S310).

Accordingly, the present device refers to the received DRP availability information elements and thus checks if there exists a data slot that the present device can reserve (S320). If there does not exist a reservation-available data slot, the reservation negotiation is immediately terminated (S380).

However, if there exists a reservation-available data slot (S330), the present device refers to the received extended DRP availability information elements and thus checks whether, out of the adjacent devices of the neighboring devices, there exist devices reserving the reservation-available data slots, and decides a data slot to reserve (S340).

If there exists an adjacent device reserving the available data slot as a result of the check, a DRP information element is generated of which topology bit value is set to 0 (S360). Further, the present device broadcasts the generated DRP information element, and then carries out a reservation negotiation with the adjacent devices.

Meanwhile, if there does not exist the adjacent devices reserving the same data slot as a result of the check, the present device generates a DRP information element of which topology bit value is set to 1 (S370). Next, the present device broadcasts the generated DRP information element, and carries out a reservation negotiation with the adjacent devices.

The topology bit value can be used as a new priority together with the existing priority stored in the DRP information element. That is, at the time reservation conflict occurs, the topology bit values are compared so that priorities can be compared between reservation negotiations. Meanwhile, if each device receives a new extended DRP availability information element and recognizes whether the adjacent devices of the neighboring devices reserve the same data slot, the topology bit value can be updated depending on a recognized result. For example, if an adjacent device is recognized which reserves the same data slot while the current topology bit value is set to 1, the topology bit value is adjusted to 0. On the contrary, if it is recognized that the adjacent device reserving the same data slot terminates data transmissions and releases the reservation state from the corresponding data slot of which current topology bit value is set to 0, the topology bit value is adjusted to 1. Thus, the priorities can be dynamically managed depending on the topology bit values.

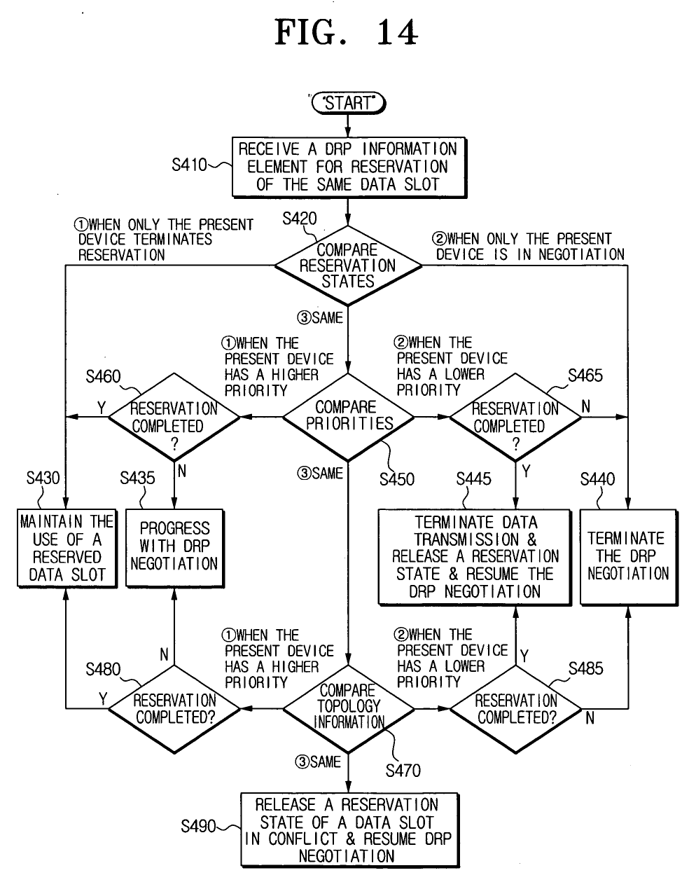

FIG. 14 is a flow chart for explaining a reservation conflict resolving method in the distributed wireless personal area network according to an exemplary embodiment of the present invention.

In FIG. 14, if a device receives from a different device a DRP information element for reserving the same data slot as itself (S410), first, the device checks a DRP control information field of the DRP information element. That is, the device checks the reservation state information field, and then compares the field to its own reservation state (S420).

As a result of the comparison, if the present device has a reservation-completed state (S=1) and the different device has a reservation-negotiating state (S=0) (\textcircled{1}), the use of the reserved data slot is kept (S430). If the present device has the reservation-negotiating state (S=0) and a different device has a reservation-completed state (S=1) (\textcircled{2}), the DRP negotiation is terminated (S440).

Meanwhile, the present device and the different device has the same reservation state (\textcircled{3}), priorities are compared (S450).

If the present device has a higher priority as a result of the priority comparison (\textcircled{1}), it is decided whether the present device terminates the reservation (S460). If the reservation is completed, the use of the reserved data slot is maintained (S430). However, if the reservation is not completed, the DRP negotiation continues for the corresponding data slot (S435).

Meanwhile, if the present device has a lower priority as a result of the priority comparison, it is checked whether the present device terminates the reservation (S435). If the reservation is terminated as a result of the check, data transmission is terminated, the reservation state of the corresponding data slot is released, and the DRP negotiation for a new data slot newly starts. However, if the reservation is under negotiation, the DRP negotiation is immediately terminated (S440).

Meanwhile, if the priority is the same as a result of the comparison (\textcircled{3}), the topology information is compared (S470). That is, comparison is made on a topology bit value of the present device and a topology bit value of the different device. The topology bit value is 0 or 1, and the device having a larger topology bit value has a higher priority.

Thus, if the topology bit value of the present device has 1 and that of the different device has 0, that is, if the present device has a higher priority (\textcircled{1}), the data slot is continually used, or the DRP negotiation continues, depending on the reservation state. That is, as a result of the check of the reservation state of the present device (S480), if the present device terminates the reservation, the use of the reserved data slot is maintained as it is (S430). Meanwhile, if the present device is in a reservation negotiation, the DRP negotiation continues (S435).

Meanwhile, if the topology bit value of the present device is 0 and that of the different device is 1, that is, if the present device has a low priority (\textcircled{2}), the negotiation is terminated or the reservation state is released, depending on the reservation state of the present device. That is, if the reservation is terminated as a result of the check on whether the present device terminates the reservation (S435), data transmissions are terminated, the reservation state of the corresponding data slot is released, and a new DRP negotiation starts for a new data slot. However, if the present device is in a reservation negotiation, the DRP negotiation is immediately terminated (S440).

Meanwhile, if even the topology bit values are the same (\textcircled{3}), all the devices are released from the reservation states of data slots in conflict, and a new DRP negotiation starts. In the above manner all, reservation conflicts can be effectively resolved.

As aforementioned, the present invention notifies of the data slot reservation state of each device within an extended area, using the extended DRP availability information element. Therefore, the present invention can avoid in advance the reservation conflict which can occur during the data slot reservation negotiation as well as effectively resolve the conflict even when the conflict occurs.

The foregoing exemplary embodiments are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A data slot reservation system in a distributed wireless personal area network including at least one device, the data slot reservation system comprising:
a first device that broadcasts an extended distributed reservation protocol (DRP) availability information element that stores data slot reservation information of at least one neighboring device located within a multiple-hop distance of the first device; and
a second device that checks reservation states of neighboring devices of the first device using the extended DRP availability information element, and performs a data slot reservation negotiation according to a result of the check.

2. The data slot reservation system as claimed in claim 1, wherein the second device decides a reservation-available data slot of data slots not reserved by the neighboring devices of the first device.

3. The data slot reservation system as claimed in claim 2, wherein the first device generates a DRP information element for the data slot reservation negotiation, and broadcasts the DRP information element together with the extended DRP availability information element.

4. The data slot reservation system as claimed in claim 3, wherein the DRP information element includes a reservation state storing field that stores a bit value notifying of a reservation negotiation progress state for a certain data slot, a priority storing field that stores a bit value notifying of a reservation priority, and a topology information storing field that stores a topology bit value notifying of whether the neighboring devices reserve a certain data slot.

5. The data slot reservation system as claimed in claim 4, wherein, if the DRP information element is received from at least one neighboring device, the first device combines the received DRP information elements to generate a DRP availability information element notifying of information on available data slots in a current superframe, and broadcasts the DRP availability information element together with the extended DRP availability information element.

6. The data slot reservation system as claimed in claim 5, wherein, if the DRP availability information element is received which notifies of the information on the available data slots in a beacon transmission range of each neighboring device from at least one neighboring device, the first device combines the received DRP availability information elements to generate the extended DRP availability information element.

7. The data slot reservation system as claimed in claim 6, wherein the extended DRP availability information element contains a number of bits corresponding to the number of data slots in the superframe, and each bit has a bit value of 0 or 1 depending on whether a corresponding data slot is reserved.

8. The data slot reservation system as claimed in claim 5, wherein the second device additionally receives a DRP information element and a DRP availability information element broadcast by the first device.

9. The data slot reservation system as claimed in claim 8, wherein the second device checks the DRP availability information element received from the first device and decides whether an available data slot exists in the current superframe, and, if the available data slot does not exist in the current superframe, terminates data slot reservation negotiation.

10. The data slot reservation system as claimed in claim 9, wherein, if the available data slot exists in the current superframe, the second device checks the extended DRP availability information element received from the first device and decides whether a data slot is reserved by neighboring devices of the first device, decides a data slot to reserve, stores a result of the decision in a topology information storing field, generates a DRP information element, and broadcasts the generated DRP information element.

11. The data slot reservation system as claimed in claim 4, wherein, if a DRP information element for the reservation negotiation for the same data slot as a data slot under current reservation negotiation is received from the first device, the second device checks a reservation negotiation progress state and a priority of the first device based on the reservation state storing field and the priority storing field of the received DRP information element.

12. The data slot reservation system as claimed in claim 11, wherein, if the first device has the same reservation negotiation progress state and the priority as the second device, the second device checks and compares a topology bit value of the topology information storing field of the DRP information element with that of the first device, and decides whether to continue a reservation negotiation.

13. A device operating in a distributed wireless personal area network, the device comprising:
an interface part that interfaces with at least one neighboring device operating in the distributed wireless personal area network;
a distributed reservation protocol (DRP) information element generating part that generates a DRP information element for data slot reservation negotiation;
a DRP availability information element generating part that, if the DRP information element is received from at least one neighboring device through the interface part, combines each received DRP information element and generates a DRP availability information element notifying of available data slot information of a current superframe;
an extended DRP availability information element generating part that, if the DRP availability information element is received from at least one neighboring device through the interface part, combines each received DRP availability information element and generates an extended DRP availability information element notifying of data slot reservation information of neighboring devices located within a multiple-hop distance; and
a control part that broadcasts through the interface part the generated DRP information element, the DRP availability information element, and the extended DRP availability information element.

14. The device as claimed in claim 13, wherein the interface part receives the DRP information element, the DRP availability information element, and the extended DRP availability information element which are broadcasted from at least one neighboring device.

15. The device as claimed in claim 14, wherein the DRP information element contains a reservation state storing field that stores a bit value notifying of a reservation negotiation progress state of a certain data slot, a priority storing field that stores a bit value notifying of a reservation priority, and a topology information storing field that stores a topology bit value notifying of whether reservation is made by a different device located within a multiple-hop distance with reference to the device itself.

16. The device as claimed in claim 15, wherein the extended DRP availability information element contains a number of bits corresponding to the number of data slots in a superframe, and each bit stores a bit value of 0 or 1 depending on whether a corresponding data slot is reserved.

17. The device claimed in claim 16, wherein the control part checks the extended DRP availability information element received from at least one neighboring device, and controls the DRP information element generating part to generate the DRP information element for reserving a data slot not reserved by devices located with the multiple-hop distance with reference to the at least one neighboring device.

18. The device as claimed in claim 16, wherein the control part checks the DRP availability information element received from at least one neighboring device, decides whether an available data slot exists in a current superframe, and, if an available data slot does not exist in the current superframe, terminates the data slot reservation negotiation.

19. The device as claimed in claim 18, wherein, if an available data slot exists in the current superframe, the control part checks the extended DRP availability information element received from at least one neighboring device, decides whether a data slot is reserved by devices located within a several-hop distance with reference to each neighboring device, decides a data slot to reserve, and controls the DRP information element generating part to store a result of the decision in the topology information storing field.

20. The device as claimed in claim 19, wherein, if the DRP information element for a reservation negotiation for the same data slot as a data slot under current reservation negotiation is received from a first device, the control part checks the reservation negotiation state and the priority of the first device from the reservation state storing field and the priority storing field of the received DRP information element.

21. The device as claimed in claim 20, wherein, if the data slot progress state and the priority of the current reservation negotiation are the same as those of the first device, the control part checks the topology bit value of the received DRP information element and decides whether to continue a reservation negotiation.

22. A data slot reservation method for devices operating in a distributed wireless personal area network, the data slot reservation method comprising:
(a) receiving an extended distributed reservation protocol (DRP) availability information element notifying of data slot reservation information used in a multiple-hop distance about each neighboring device from at least one neighboring device; and
(b) checking reservation states of the neighboring devices with reference to the extended DRP availability information element, and reserving a certain data slot according to a result of the check.

23. The data slot reservation method as claimed in claim 22, wherein (b) includes deciding a data slot to reserve out of data slots not reserved by the neighboring devices.

24. The data slot reservation method as claimed in claim 23, further comprising receiving a DRP information element for a data slot reservation negotiation from at least one neighboring device.

25. The data slot reservation method as claimed in claim 24, wherein the DRP information element contains a reservation state storing field that stores a bit value notifying of a reservation negotiation progress state for a certain data slot, a priority storing field that stores a bit value notifying of a reservation priority, and a topology information storing field that stores a topology bit value notifying of whether reservation is made by a different device located within the multiple-hop distance.

26. The data slot reservation method as claimed in claim 25, further comprising:
combining the DRP information element received from at least one neighboring device and generating a DRP availability information element notifying of information on available data slots in a current superframe; and
broadcasting the generated DRP availability information element.

27. The data slot reservation method as claimed in claim 26, further comprising:
receiving from at least one neighboring device the DRP availability information element notifying of the information on available data slots within a beacon transmission range of each of at least one neighboring device; and
combining the received DRP availability information elements and generating the extended DRP availability information element.

28. The data slot reservation method as claimed in claim 27, wherein the extended DRP availability information element contains a number of bits corresponding to the number of data slots in a superframe, and each bit stores a bit value of 0 or 1 depending on whether a corresponding data slot is reserved.

29. The data slot reservation method as claimed in claim 27, wherein (b) includes:
checking the DRP availability information element received from at least one neighboring device to determine whether an available data slot exists in a current superframe; and
terminating data slot reservation negotiation if it is determined that an available data slot does not exist as a result of the checking.

30. The data slot reservation method as claimed in claim 29, wherein (b) further includes:
checking, if it is determined that the available data slot exists as a result of the checking, the extended DRP available information element received from at least one neighboring device, deciding whether the availability data slot is reserved by a different device located within the several-hop distance around at least one neighboring device, and deciding a data slot to reserve; and storing the topology information storing field as a result of the decision to generate the DRP information element, and broadcasting the generated DRP information element.

31. The data slot reservation method as claimed in claim 25, wherein (b) further includes checking, if the DRP information element for a reservation negotiation for the same data slot as a data slot under current reservation negotiation is received from a first device, the reservation negotiation progress state and the priority of the first device from the reservation state storing field and the priority storing field of the received DRP information element.

32. The data slot reservation method as claimed in claim 31, wherein (b) further includes, if the reservation negotiation progress state and the priority of a data slot under current reservation negotiation are the same as the reservation negotiation progress state and the priority of the first device, checking the topology bit value of the DRP information element received from the first device, and deciding whether to continue the reservation negotiation.

33. The data slot reservation method as claimed in claim 32, wherein (b) further includes:
releasing all reservation states of the data slot and progressing with a new reservation negotiation, if the topology bit value of the received DRP information element is the same as the topology bit value thereof;
terminating the reservation negotiation if the topology bit value of the received DRP information element is larger than the topology bit value thereof; and
continuing the reservation negotiation for the data slot if the topology bit value of the received DRP information element is smaller than the topology bit value thereof.
